(19) United States
(12) Patent Application Publication
(10) Pub. No.: US 2009/0311399 A1
(43) Pub. Date: Dec. 17, 2009

(54) Baking oven having a suspended baked goods carrier

(76) Inventor: Michael Koos, Arnstein (DE)

Correspondence Address: MUIRHEAD AND SATURNELLI, LLC, 200 FRIBERG PARKWAY, SUITE 1001, WESTBOROUGH, MA, 01581, US

(21) Appl. No.: 12/311,082

(22) PCT Filed: Sep. 14, 2007
(86) PCT No.: PCT/EP2007/059682

§ 371 Date: Mar. 18, 2009

(30) Foreign Application Priority Data
Sep. 18, 2006 (DE) 10 2006 044 336.5

(51) Int. Cl. A21B 1/44; A23L 1/01; A47J 37/00

(52) U.S. Cl. 426/523; 99/443 R; 126/21 A; 219/392

(57) ABSTRACT

A baking oven has a supporting device for a baked goods carrier, a lifting device for lifting the supporting device, and a drive motor for rotating the supporting device. The lifting device is situated in such a way that the drive motor and the supporting device are lifted jointly to provide a particularly simple and reliable baking oven.

### TECHNICAL FIELD

The present invention relates to a baking oven having a supporting device for a baked goods carrier, a lifting device for lifting the supporting device and a drive motor for rotating the supporting device.

### BACKGROUND INFORMATION

In particular in hot air baking ovens, in which a fan creates a stream of air inside the baking chamber of the baking oven, it is often desirable to continuously vary the position of the individual dough pieces in the baking chamber during the baking process to ensure uniform baking. An irregular temperature distribution inside the baking chamber may be compensated by movement of the dough pieces in the baking chamber, by a rotary drive, which rotates the baked goods carrier during the baking process, so this continuous movement of the dough pieces (baked goods) during the baking process may be achieved. The baked goods are usually placed on several tiers on a rollable baked goods cart, also known as a multi-tray cart.

To allow the rotation of the multi-tray cart, according to U.S. Pat. No. 3,595,178, the supporting device of the baking oven and the multi-tray cart are provided with a roller/rail system situated above the multi-tray cart. The row of rollers and the rail assigned to them are positioned obliquely to one another, so that the multi-tray cart is lifted when inserted. Alternatively, the row of rollers and the rail are parallel to one another, while the floor surface leading into the baking chamber of the baking oven declines. The rollers on the multi-tray cart lose contact with the floor on insertion into the baking oven. This system has proven to be difficult in handling of the rollable baked goods carrier.

Other systems operate with a lifting device for lifting the supporting device within the baking oven.

For example, EP 0 112 786 A1 describes a system in which the lifting device is formed by two half-shafts having threaded elements (external thread and internal thread) that are screwable one into the other. The upper half-shaft is supported on the oven housing and is driven by a drive motor mounted on the outside of the oven housing. This system is quite complicated and fault-prone. In particular, the lifting device, which includes two threaded elements that may be screwed one into the other near the baking chamber, is very failure-prone due to the high temperatures prevailing in this area and the high level of soiling due to flour and similar suspended particles.

DE 19 37 472 (corresponding to U.S. Pat. No. 3,641,945) describes a shaft, on whose lower end the supporting device is situated, which is supported on an axial bearing. The axial bearing may be lifted with a suitable lifting device, so that the shaft and the supporting device attached to it may be lifted in this way. A belt pulley, which is connected by a drive belt to a corresponding belt pulley of a drive motor, is provided on the upper shaft end. Such a belt drive is failure-prone due to the soiling and the temperature fluctuations prevailing in bakeries.

A corresponding belt drive is described in DE 25 19 849 C2 (corresponding to U.S. Pat. No. 3,954,053). In this case, the lifting device is operated by closing the door to the baking oven.

DE 79 12 290 U1 describes an oven having a lift linkage for lifting a shaft extending through the top of the oven into the baking chamber. A drive motor mounted on the oven housing is again provided as the rotary drive and is connected to the shaft by a drive belt. A hollow shaft is attached to the belt pulley and is connected to a retaining bracket in the baking chamber. The supporting device (claw 9) is situated on an inner shaft within the hollow shaft, which may be lifted axially. The design having two shafts, one displaceable into the other, is very complex and is failure-prone because of the risk of soiling in the bakery.

DE 198 24 967 A1 describes a device for baking meat products, in which a shaft may be lifted via a pneumatic cylinder and a chain. The supporting device is situated at the lower end of the shaft inside the baking chamber. The pneumatic cylinder is situated on the top of the oven. A first gearwheel having a long extension in the axial direction of the shaft is provided on the shaft. This gearwheel engages with the driven gearwheel of a stationary geared motor mounted on the top of the baking oven. A susceptibility to soiling is also to be feared in the present case due to the engaging force transfer elements is the rotary drive (gearwheels), which are longitudinally displaceable and are situated openly on the top of the baking oven. Furthermore, metal abrasion from the gearwheels may produce particles that would contaminate the bakery in an unacceptable manner.

### DISCLOSURE OF THE INVENTION

The object of the present invention is to create a particularly simple and reliable baking oven of the type defined above.

This object is achieved according to the present invention by the fact that the lifting device is situated in such a way that the drive motor and the supporting device are lifted jointly. In practice, the supporting device may be situated on the lower end of a vertical shaft. The drive motor is situated at the upper end of this shaft. The lifting device may be coupled to this vertical shaft to lift it.

According to the present invention, it is possible to create a lifting of the supporting device without any shift in height between the motion transfer means of the drive motor and the motion transfer means of the supporting device. Consequently, the use of coupling elements which compensate for such shifts in height (e.g., belt drives or axially displaceable gearings or threads) may be omitted. The drive motor is simply lifted jointly with the supporting device and the baked goods carrier (e.g., cart) attached to it, so that in each lift position of the supporting device, the relative lift position of the motor is constant in relation to the relative lift position of the supporting device. A simple geared motor with an encapsulated gear provided on the motor output shaft may be used as the drive motor. The driven gearwheel of the gear may be fixedly connected to the upper end of the shaft.

The lower end of the shaft protrudes into the baking chamber of the baking oven into which the cart or other baked goods carriers is/are introduced. The shaft passes through the insulated wall of the baking chamber, so that the geared motor may be located outside of the baking chamber on the top of the baking oven housing.

In a practical embodiment, an axial bearing for the shaft is situated close to the upper end of the shaft. The axial bearing is preferably also situated outside of the baking chamber to prevent damage due to the elevated temperature in the baking chamber.

The axial bearing is preferably lifted by the lift mechanism. The shaft is moved upward with its supporting device situated on its lower end and with the drive motor situated on its upper end.

In a practical embodiment, the lift mechanism includes a linear drive. This linear drive may operate a linkage for lifting the axial bearing. The length of the lift of the linear drive may be adjustable. In particular, the lowered position in which the supporting device receives and releases the baked goods carrier may be adjustable, the lifted position of the baked goods carrier being invariable. In this way, the lift of the lift drive may be adjusted optimally to the height of the baked goods carrier introduced into the baking oven. In fact, the only lift distance traveled is that required to move the supporting device to a height at which the baked goods carrier may be coupled and uncoupled.

The linkage may be a parallel lever linkage, which introduces the torque of the drive motor into the baking oven housing. In practice, a supporting metal sheet may be secured between the two parallel levers of this linkage, the geared motor being securely bolted to this supporting metal sheet.

When the baked goods carrier is replaced, the height of the lift may be changed, so that the new baked goods carrier may be coupled to and released from the supporting device with no problem.

### BRIEF DESCRIPTION OF THE DRAWINGS

An embodiment of the present invention is described in greater detail below with reference to the accompanying drawings.

FIG. 1 shows a front view of a baking oven according to the present invention;

FIG. 2 shows a sectional diagram of the baking oven from FIG. 1, the section being drawn at the level of the drive motor;

FIG. 3 shows a top view onto part of the top of the baking oven from FIGS. 1 and 2; and

FIG. 4 shows a view along the sectional line A-A in FIG. 3, showing the lift drive and rotary drive for the baked goods carriers.

### EMBODIMENT(S) OF THE INVENTION

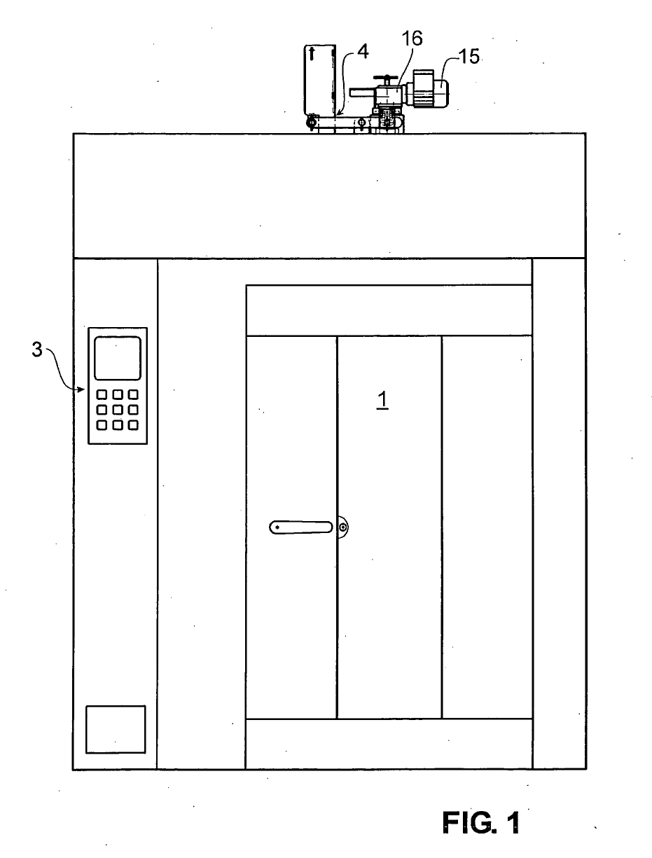

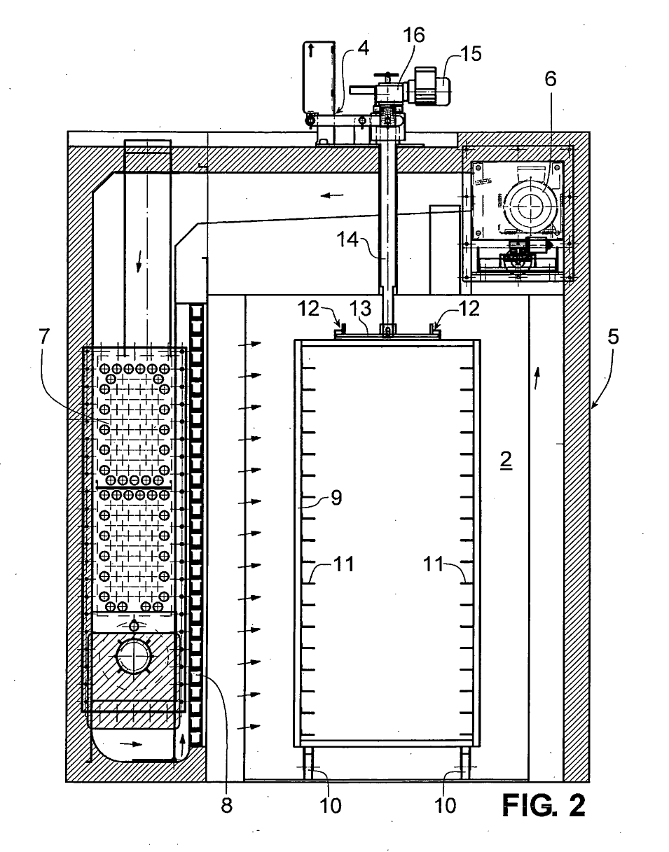

FIG. 1 shows the front view of the housing of a baking oven according to the present invention. The oven housing includes a door 1, which is used for opening and closing the baking chamber 2 (see FIG. 2). To the left of the door is an input and display field 3, where operating parameters of the oven may be input, displayed and checked. Above the top of the baking oven, a rotary and lift drive for the baked goods carriers is visible, including a lifting device 4, which is described below, and a geared motor, i.e., a drive motor 15 having a gear 16 flange-connected thereto.

The design features of the baking oven are shown more clearly in FIG. 2. The outside wall of oven housing 5 is made of a thermally insulating material. A fan 6 is installed at the upper right in the oven. Fan 6 generates a stream of air through a heating register 7. The air flowing through heating register 7 then passes through a vapor apparatus 8 and is then passed through baking chamber 2.

A baked goods carrier 9 is visible in baking chamber 2, which is designed as a baking cart or a multi-tray cart. It has rollers 20 with which multi-tray cart 9 may be rolled into baking chamber 2 and rolled out of baking chamber 2. Multi-tray cart 9 has supporting bars 11 on both sides onto which baking trays may be pushed. In practice, multi-tray cart 9 is equipped with a plurality of baking trays situated one above the other (eighteen in the present case), dough pieces sitting on these trays a small distance apart to be able to achieve a high baking output by the oven.

In the upper area multi-tray cart 9 has coupling devices 12 which cooperate with a supporting device 13 of the baking oven. Coupling devices 12 in the present case are rails that are pushed over a plate-shaped or bracket-shaped supporting device 13. When supporting device 13 is lifted, the rails forming coupling device 12 rest on supporting device 13. Multi-tray cart 9 is lifted until its rollers 10 are no longer in contact with the floor of baking chamber 2.

Supporting device 13 is situated on the lower end of a shaft 14, which is coupled to lifting device 4 and geared motor 15, 16.

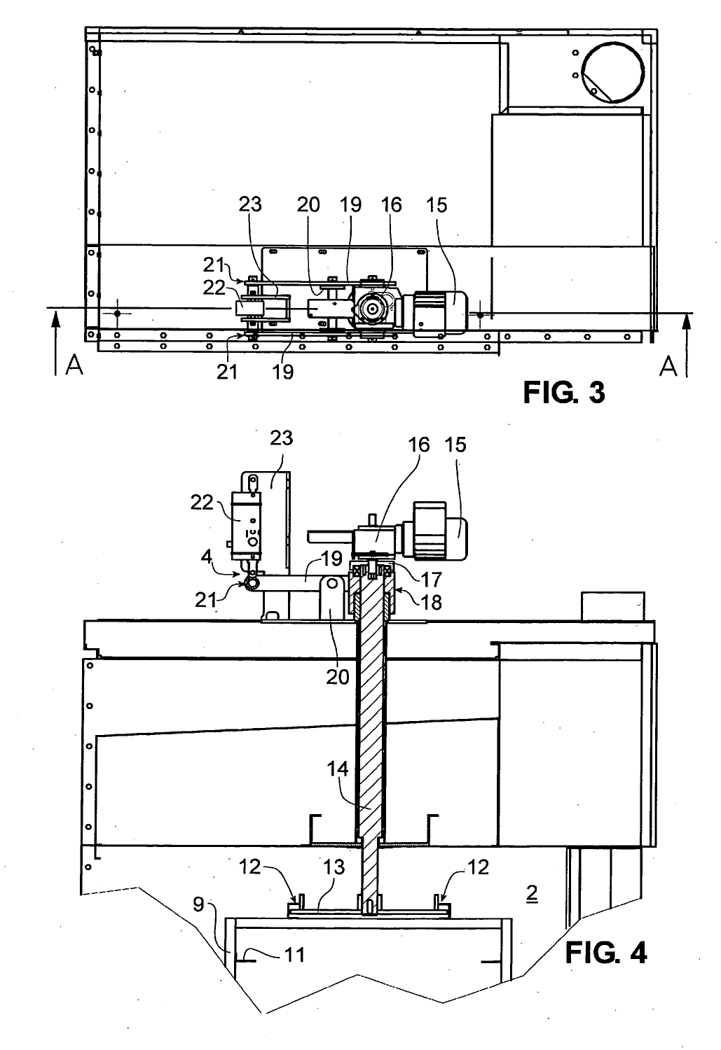

The details of lifting device 4 and the rotary device for the baked goods carrier may be seen in FIGS. 3 and 4 in particular. The rotary drive has a drive motor 15, which is fixedly coupled to an encapsulated gear 16 and consequently forms a geared motor. The output shaft of gear 16 is connected to shaft 14 in a rotationally fixed manner. The upper end of shaft 14 is fixedly connected to a bearing shell 17 of axial bearing 18. The second bearing shell of axial bearing 18 is connected to a lever linkage having two parallel levers 19. Two levers 19 are supported somewhat eccentrically on a bearing block 20. The lever linkage having axial bearing 18 is situated outside of the oven housing, i.e., in an environment with a temperature below 100° C. This prevents high temperatures such as those prevailing in the baking chamber from interfering with trouble-free running of the axial bearing.

End 21 of two parallel levers 19 opposite axial bearing 18 is coupled to a linear drive 22 with an adjustable lift. When linear drive 22 is activated, it presses lever ends 21 of two parallel levers 19 downward, so that axial bearing 18 is lifted at the other ends of levers 19. Simultaneously with the lifting of axial bearing 18, shaft 14 and drive motor 15 mounted on it are lifted. Drive motor 15 is fixedly connected to gear 16. Gear 16 is supported in the axial direction on bearing shell 17, to which the upper end of shaft 14 is connected. Furthermore, gear 16 is framed between two parallel levers 19 of the lever linkage, so that the lever linkage introduces the torques of drive motor 15 into the oven housing via bearing blocks 20.

Finally, FIGS. 3 and 4 show an angle bracket 23, which is securely screwed onto the oven and to which linear drive 22 is attached.

The system according to the present invention allows very reliable and fault-free operation. Shaft 14 is coupled directly to the output shaft of gear 16, so that no shifting of height between the motor/gear unit and shaft 14 driven by it need be compensated. All the motion-transferring elements are held in a closed housing or are covered, so that there need be no fear of any impairment of operation due to soiling.

The linkage having two parallel levers 19, which produces the lift of multi-tray cart 9, may also have an extremely simple and reliable design. The simple bearings of the linkage operate reliably even when there are great fluctuations in temperature and even in an environment with a high level of soiling.

Linear drive 22 preferably has an adjustable lift. The lowered position of supporting device 13 may thus be varied according to the height of multi-tray cart 9 introduced into baking chamber 2.

In practice, the lift and rotary drive 4, 15, 16 visible in the figures may, of course, be covered by a screen, so that it is not visible to the observer in front of or at the side of the oven.

### LIST OF REFERENCE NUMERALS

1 door
2 baking chamber
3 input and display field
4 lifting device
5 oven housing
6 fan
7 heating register
8 vapor apparatus
9 baked goods carrier, multi-tray cart
10 roller
11 supporting bar
12 coupling device
13 supporting device
14 shaft
15 drive motor
16 gear
17 bearing shell
18 axial bearing
19 lever
20 bearing block
21 lever end
22 linear drive
23 angle bracket

1. A baking oven, comprising
a supporting device for a baked goods carrier;
a lifting device for lifting the supporting device; and
a drive motor for rotating the supporting device, wherein the lifting device is situated in such a way that drive motor and the supporting device are lifted jointly.

2. The baking oven as recited in claim 1, characterized in that wherein the supporting device is situated on the lower end of a vertical shaft, and the drive motor is situated on the upper end of the vertical shaft, the lifting device being coupled to the vertical shaft (14) to lift the latter.

3. The baking oven as recited in claim 1, wherein the drive motor is a geared motor.

4. The baking oven as recited in claim 2, wherein the shaft is supported by an axial bearing near the upper end of the shaft.

5. The baking oven as recited in claim 4, wherein the axial bearing is liftable by the lifting device.

6. The baking oven as recited in claim 1, wherein the lifting device includes a linear drive.

7. The baking oven as recited in claim 4, wherein the lifting device operates a linkage for lifting the axial bearing.

8. The baking oven as recited in claim 7, wherein the linkage has two parallel levers which introduce torque of the drive motor into a housing of the baking oven.

9. The baking oven as recited in claim 6, wherein lift of the linear drive is adjustable.

10. The baking oven as recited in claim 9, wherein a lowered position in which the supporting device receives and releases a multi-carrier cart is adjustable, the lifted position of the baked goods carrier being invariable.

11. A baking oven, comprising:
a housing that includes a baking chamber;
a heating unit that provides heat to the baking chamber;
a supporting device disposed in the baking chamber that supports a baked goods carrier;
a drive motor for rotating the supporting device; and
a lifting device that jointly lifts the supporting device and the drive motor.

12. The baking oven as recited in claim 11, wherein the supporting device is disposed on the lower end of a shaft, and the drive motor is disposed on the upper end of the shaft, the lifting device being coupled to the shaft.

13. The baking oven as recited in claim 12, wherein the shaft is supported by an axial bearing near the upper end of the shaft.

14. The baking oven as recited in claim 13, wherein the axial bearing is liftable by the lifting device.

15. The baking oven as recited in claim 14, wherein the lifting device operates a linkage for lifting the axial bearing.

16. The baking oven as recited in claim 11, wherein the drive motor is a geared motor.

17. The baking oven as recited in claim 11, wherein the lifting device includes a linear drive.

18. The baking oven as recited in claim 11, wherein lift of the linear drive is adjustable.

19. The baking oven as recited in claim 18, wherein a lowered position in which the supporting device receives and releases a multi-carrier cart is adjustable, the lifted position of the baked goods carrier being invariable.

20. A method for baking, comprising:
providing heat to a baking chamber supporting a baked goods carrier using a supporting device disposed in the baking chamber;
rotating the supporting device using a drive motor; and
jointly lifting the supporting device and the drive motor.
